(19) United States
(12) Patent Application Publication
(10) Pub. No.: US 2011/0104531 A1
(43) Pub. Date: May 5, 2011

(54) Cap Assembly and Second Battery Including the Same

(75) Inventor: Jang-Ho Lee, Suwon (KR)

(73) Assignee: SAMSUNG SDI CO., LTD., Yongin-si (KR)

(21) Appl. No.: 12/846,499

(22) Filed: Jul. 29, 2010

(30) Foreign Application Priority Data
Nov. 3, 2009 (KR) 10-2009-0105487

(51) Int. Cl. H01M 2/12

(52) U.S. Cl. 429/82

(57) ABSTRACT

A cap assembly comprises a cap formed of a metal having electric conductivity, a safety vent formed of a metal having electric conductivity and disposed below the cap, and a positive temperature coefficient (PTC) resistance layer which includes a conductive polymer composition having PTC characteristics and which is disposed between the cap and the safety vent. A secondary battery comprises a can including an open portion at one side, an electrode assembly accommodated in the can, and a cap assembly as described above.

### CLAIM OF PRIORITY

This application makes reference to, incorporates the same herein, and claims all benefits accruing under 35 U.S.C. §119 from an application earlier filed in the Korean Intellectual Property Office on 3 Nov. 2009 and there duly assigned Serial No. 10-2009-0105487.

### BACKGROUND OF THE INVENTION

### Field of the Invention

The present invention relates to a cap assembly and a secondary battery including the same and, more particularly, to a cap assembly in which an internal resistance is reduced, wherein elements of the cap assembly are integrated in the cap assembly, and wherein the secondary battery including the cap assembly is easily assembled.

### SUMMARY OF THE INVENTION

One or more embodiments of the present invention include a cap assembly of a secondary battery in which an internal electrical resistance is reduced, and a secondary battery including the cap assembly.

One or more embodiments of the present invention include a cap assembly of a secondary battery, wherein elements of the cap assembly are integrated with one another.

One or more embodiments of the present invention include a secondary battery which is easily manufactured.

Additional aspects will be set forth in part in the description which follows and, in part, will be apparent from the description, or may be learned by practice of the presented embodiments.

According to one or more embodiments of the present invention, a cap assembly includes a component on at least one surface of a positive temperature coefficient (PTC) resistance layer instead of electrode layers disposed on two surfaces of the PTC resistance layer so that the component functions as an electrode layer for the PTC resistance layer, and a secondary battery includes such a cap assembly.

According to one or more embodiments of the present invention, a cap assembly of a secondary battery includes a cap formed of a metal having electric conductivity; a safety vent formed of a metal having electric conductivity and disposed below the cap; and a PTC resistance layer which includes a conductive polymer composition having PTC characteristics, and which is disposed between the cap and the safety vent.

A surface of the PTC resistance layer may be attached to a bottom surface of the cap, and the other surface of the PTC resistance layer may be attached to an upper surface of the safety vent.

The cap assembly may further include a metal layer formed of a material having electric conductivity and formed between the PTC resistance layer and the safety vent, wherein a surface of the PTC resistance layer is attached to a bottom surface of the cap, and another surface of the PTC resistance layer is attached to an upper surface of the metal layer.

The cap assembly may further include a current blocking circuit substrate interposed between the PTC resistance layer and the safety vent, wherein a surface of the PTC resistance layer is attached to a bottom surface of the cap, and another surface of the PTC resistance layer is attached to a terminal disposed on an upper surface of the current blocking circuit substrate.

The cap assembly may further include a metal layer formed of a material having electric conductivity and a current blocking circuit substrate sequentially disposed below the PTC resistance layer, wherein a surface of the PTC resistance layer is attached to a bottom surface of the cap, another surface of the PTC resistance layer is attached to an upper surface of the metal layer, and a bottom surface of the metal layer is attached to a terminal disposed on an upper surface of the current blocking circuit substrate.

The cap assembly may further include an insulating material disposed below the safety vent, and a lower cap that formed of a metal having electric conductivity and disposed below the insulating material.

The cap assembly may further include a subplate formed of a metal having electric conductivity and disposed below the lower cap.

The cap assembly may further include a gasket which surrounds circumferential surfaces of the cap, the safety vent and the PTC resistance layer, and which insulates the can and the cap assembly of the secondary battery from each other.

According to one or more embodiments of the present invention, a secondary battery includes a can including an open portion at one side; an electrode assembly accommodated in the can; and a cap assembly. The cap assembly includes: a cap formed of a metal having electric conductivity; a safety vent formed of a metal having electric conductivity and disposed below the cap; and a positive temperature coefficient (PTC) resistance layer which includes a conductive polymer composition having PTC characteristics, and which is disposed between the cap and the safety vent, wherein the cap assembly is coupled to the can so as to seal the can.

### BRIEF DESCRIPTION OF THE DRAWINGS

A more complete appreciation of the invention, and many of the attendant advantages thereof, will be readily apparent as the same becomes better understood by reference to the following detailed description when considered in conjunction with the accompanying drawings, in which like reference symbols indicate the same or similar components, wherein:

FIG. 1 is an exploded perspective view of elements of a secondary battery, including a cap assembly, according to an embodiment of the present invention, wherein the coupling relationship between the elements is shown;

FIG. 2 is a perspective view of a secondary battery, including the cap assembly of FIG. 1, which is completely assembled as the elements are coupled to one another;

FIG. 3 is a cross-sectional view of the secondary battery of FIG. 1;

FIG. 4 is an exploded perspective view illustrating the coupling relationship between elements of the cap assembly included in the secondary battery of FIG. 3;

FIG. 5 is a cross-sectional view illustrating a secondary battery, including a cap assembly, according to another embodiment of the present invention;

FIG. 6 is an exploded perspective view illustrating the coupling relationship between elements of the cap assembly included in the secondary battery of FIG. 5;

FIG. 7 is a cross-sectional view illustrating a secondary battery, including a cap assembly, according to another embodiment of the present invention; and

FIG. 8 is a cross-sectional view illustrating a secondary battery, including a cap assembly, according to another embodiment of the present invention.

### DETAILED DESCRIPTION OF THE INVENTION

Lithium secondary batteries are compact, have a large capacity, and have a high operational voltage and high energy density per weight unit. Thus, lithium secondary batteries are used in various types of electric and electronic appliances. The lithium secondary batteries are classified as can types and pouch types according to the form of an external material accommodating an electrode assembly. The can type lithium secondary batteries are divided into an angled type and a cylinder type.

The cylinder type secondary batteries include a can which provides the external appearance, an electrode assembly mounted in the can, and a cap assembly which is coupled to an open portion disposed at an upper end of the can. The cap assembly includes various elements, such as a cap and a safety vent. When coupling the cap assembly to the can, the elements are sequentially coupled to an open portion at an upper end of the can. However, when the above coupling method according to the related art is used, the assembling operation thereof is complicated and takes a long time to complete.

Attempts have been made to simplify the method of coupling the cap assembly to the open portion at the upper end of the can by integrating the various elements of the cap assembly. Examples of such attempts include welding so as to couple the elements to one another.

The cap assembly generally includes a positive temperature coefficient (PTC) device. However, due to the fact that PTC device has characteristics which vary due to temperature, it is difficult to integrate elements of the cap assembly by welding the PTC device and other elements. The thickness of a metal electrode layer of the PTC device may be increased in order to improve the weldability of the PTC device but, in this case, electrical resistance increases.

Also, due to electrical contact resistance between various elements of the cap assembly which are integrated with one another, the total electrical resistance of the lithium secondary battery increases, which degrades the performance of the lithium secondary battery.

Reference will now be made in detail to embodiments, examples of which are illustrated in the accompanying drawings, wherein like reference numerals refer to like elements throughout. In this regard, the present embodiments may have different forms and should not be construed as being limited to the descriptions set forth herein. Accordingly, the embodiments are merely described below, by referring to the figures, to explain aspects of the present description.

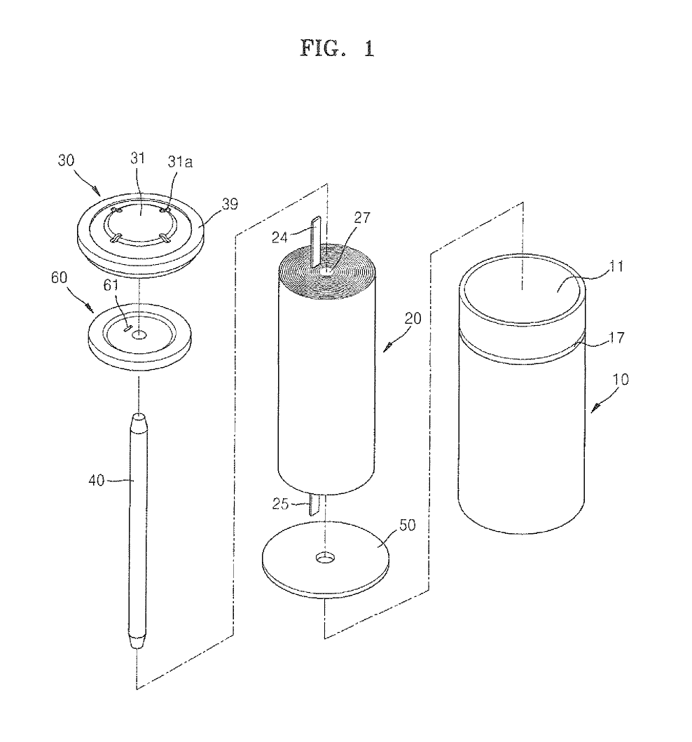

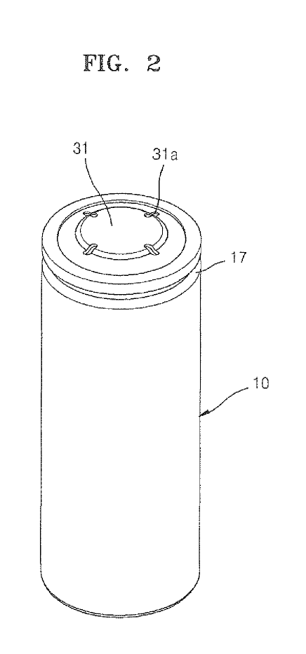

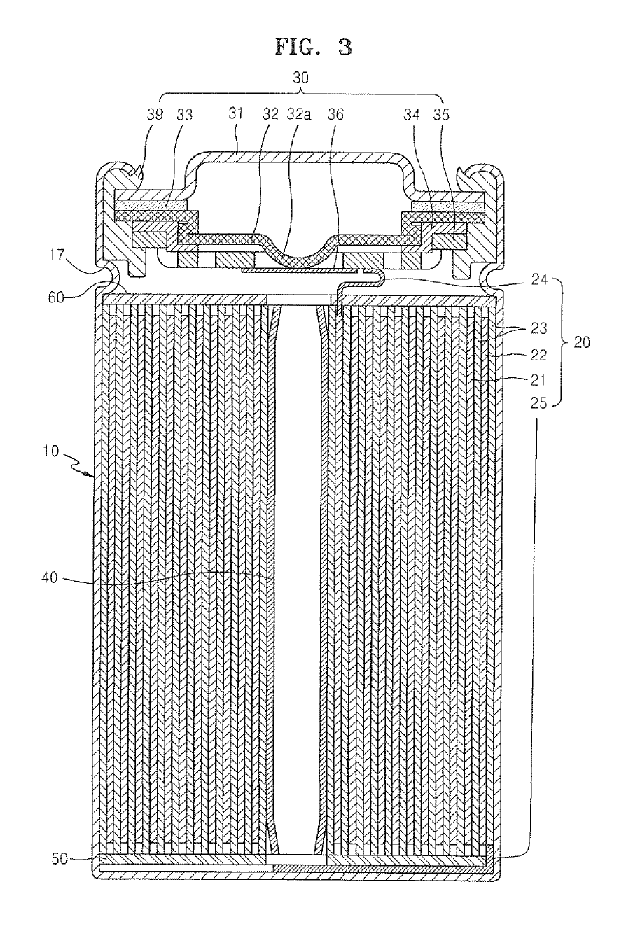

FIG. 1 is an exploded perspective view of elements of a secondary battery, including a cap assembly, according to an embodiment of the present invention, wherein the coupling relationship between the elements is shown; FIG. 2 is a perspective view of a secondary battery including the cap assembly of FIG. 1, which is completely assembled as the elements are coupled to one another; and FIG. 3 is a cross-sectional view of the secondary battery of FIG. 1.

The secondary battery, including the cap assembly, illustrated in FIGS. 1 thru 3 includes a can 10, an electrode assembly 20 accommodated in the can 10, and a cap assembly 30 closely sealing the can 10.

The can 10 is cylindrical and includes an open portion 11. The can 10 includes a sidewall which creates a cylindrical space and a bottom surface which closes a lower open portion. The can 10 may be formed by using a material such as iron, stainless steel, an aluminum alloy, or the like, and by using a deep drawing method.

The electrode assembly 20 (see FIGS. 1 and 3) is formed by interposing a separator 23 between a positive electrode plate 21 and a negative electrode plate 22, and winding the stack of the positive electrode plate 21, the negative electrode plate 22, and the separator 23 into a jelly roll form. A positive electrode tab 24 is attached to the positive electrode plate 21 of the electrode assembly 20, and a negative tab 25 is attached to the negative electrode plate 22. A path 27 is formed in a center portion of the wound electrode assembly 20. Also, a center pin 40 is inserted into the path 27 to prevent deformation of the electrode assembly 20.

The positive electrode plate 21 includes a positive electrode collector and a positive electrode active material layer (not shown). The positive electrode active material layer includes a layered compound including lithium, a binder which increases a bonding force, and a conductive material which increases conductivity. The positive electrode collector is usually formed of aluminum, functions as a path through which charges generated in the positive electrode active layer move, and supports the positive electrode active material layer.

The negative electrode plate 22 includes a negative electrode collector and a negative electrode active material layer. The negative electrode active material layer includes carbon. In detail, the negative electrode active material layer includes hard carbon or graphite, and a binder which increases a bonding force between particles of the negative electrode active material layer. The negative electrode collector is usually formed of copper, functions as a path through which charges generated in the negative electrode material layer move, and supports the negative electrode active material layer.

The separator 23 is interposed between the positive electrode plate 21 and the negative electrode plate 22 so as to insulate the positive electrode plate 21 and the negative electrode plate 22 from each other, and passes charges of the positive electrode plate 21 and the negative electrode plate 22. The separator 23 is usually formed of polyethylene (PE) or polypropylene (PP), but is not limited thereto.

The electrode assembly 20 (FIG. 1) is inserted into the can 10 via the open portion 11 of the can 10. A lower insulation plate 50 is disposed on the bottom surface of the can 10 before inserting the electrode assembly 20. The lower insulation plate 50 insulates the electrode assembly 20 and the can 10 from each other. The lower insulation plate 50 includes a hole which passes through the negative tab 25. The negative tab 25 passes through the hole of the lower insulation plate 50 so as to be electrically connected to the can 10.

The cap assembly 30 has a cylindrical shape and a size corresponding to the open portion 11 of the can 10, and is coupled to the open portion 11 of the can 10. The cap assembly 30 may be coupled to the can 10 by using a clamping process in which a pressure is applied toward an inner portion and a lower portion of the open portion 11 of the can 10 so as to seal the can 10.

After the electrode assembly 20 is inserted into the can 10, an upper insulation plate 60 (FIG. 1) is mounted on the electrode assembly 20. The positive electrode tab 24 protrudes upward through a hole 61 of the upper insulation plate 60.

When the electrode assembly 20 and the upper insulation plate 60 are inserted into the can 10, the sidewall of the can 10 is inwardly bent at a height of the upper insulation plate 60, thereby forming a bead 17. The bead 17 prevents movement of the electrode assembly 20 either upward or downward inside the can 10 even when an impact occurs from outside the electrode assembly 20.

When an electrolyte solution is injected into the can 10 so as to cover the electrode assembly 20, the cap assembly 30 is coupled to the open portion 11 of the can 10, thereby sealing the can 10. The cap assembly 30 may be installed in such a manner that various components of the cap assembly 30 are sequentially coupled to the can 10. Alternatively, the cap assembly 30 may be formed by assembling various components as one assembly, and then coupling the assembly to the can 10.

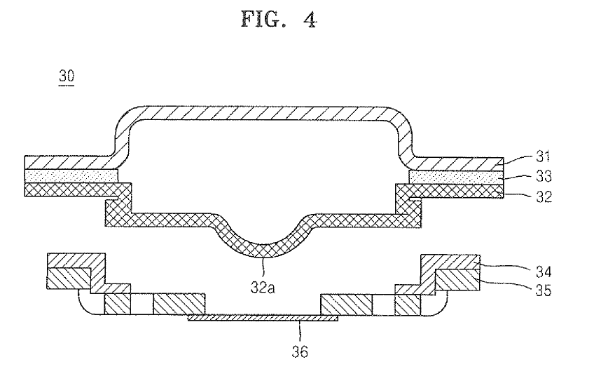

FIG. 4 is an exploded perspective view illustrating the coupling relationship between elements of the cap assembly included in the secondary battery of FIG. 3.

The cap assembly 30 includes a cap 31 which functions as an electrode terminal, a safety vent 32 disposed below the cap 31, and a positive temperature coefficient (PTC) resistance layer 33 disposed between the cap 31 and the safety vent 32.

The cap 31 is a circular plate formed of a metal having electric conductivity such as stainless steel, wherein a center portion of the circular plate protrudes upward. The cap 31 may include a plurality of through holes (not shown) for discharging gas.

The safety vent 32 is a circular plate formed of a metal having electric conductivity and is disposed below the cap 31. The safety vent 32 electrically connects the electrode assembly 20 and the cap 31. The safety vent 32 includes a protrusion 32a which protrudes downward. When internal pressure of the can 10 increases, the safety vent 32 expands and then ruptures. Accordingly, internal gas of the can 10 is discharged to the outside, thereby preventing the secondary battery from exploding.

The PTC resistance layer 33 includes a conductive material having PTC characteristics, and is disposed between the cap 31 and the safety vent 32.

A PTC device included in a cap assembly according to the related art includes a PTC resistance layer, and a plurality of metal electrode layers formed on both surfaces of the PTC resistance layer. As the PTC device having a layered structure, including at least three layers, is disposed between a cap and a vent, the total electrical resistance of the secondary battery increases. Also, when assembling the cap assembly, the PTC device has to be additionally considered, and thus the assembling process of the cap assembly is complicated.

However, according to the current embodiment of the present invention, no metal electrode layer is formed on either surface of the PTC resistance layer 33 of the cap assembly 30, a side surface of the PTC resistance layer 33 is attached to a bottom surface of the cap 31, and the other side surface of the PTC resistance layer 33 is attached to the safety vent 32. Since the cap 31 and the safety vent 32, which directly contact the PTC resistance layer 33, function as metal electrode layers which respectively transmit electricity to the PTC resistance layer 33, an assembly of the cap 31, the safety vent 32, and the PTC resistance layer 33 may function as a PTC device. Accordingly, the cap assembly 30, including the PTC resistance layer 33 which is integrally formed, has a smaller electrical resistance than the cap assembly of the secondary battery of the related art in which the PTC device is additionally installed.

The PTC resistance layer 33 blocks electrical current between the cap 31 and the safety vent 32 so as to prevent overheating and to prevent the secondary battery from exploding when an overcurrent flows between the cap 31 and the safety vent 32 for a period of time or when the temperature between the cap 31 and the safety vent 32 increases to a critical value or greater.

The PTC resistance layer 33 may include a conductive polymer composition. The conductive polymer composition includes a polymer and a particle-shaped conductive filament which is distributed within the polymer. Examples of the polymer include a crystalline organic polymer material. In detail, the examples of the polymer include polyorefin, such as polyethylene or ethylene copolymer, and fluorine polymer, such as poly fluorine vinylidene. Examples of the particle-shaped conductive filament include carbon black, graphite, a metal, and a glass material coated with a metal oxide conductive material.

The PTC resistance layer 33 may be attached to the cap 31 and the safety vent 32 using various methods. For example, the PTC resistance layer 33 and the cap 31 and safety vent 32 may be integrated with one another so that the cap 31 and the safety vent 32 are attached to the PTC resistance layer 33 by applying pressure thereto when fusing a conductive polymer composition which is a source material of the PTC resistance layer 33.

Alternatively, a conductive polymer composition may be pressed and then cut to manufacture the PTC resistance layer 33 in a ring-shaped circular plate, the cap 31 may be attached to a surface of the PTC resistance layer 33, and the safety vent 32 may be attached to the other surface of the PTC resistance layer 33. The PTC resistance layer 33 may be attached to the cap 31 or the safety vent 32 using, for example, a conductive adhesive.

When the cap 31 and the safety vent 32 are attached to the PTC resistance layer 33, they may be treated as one integrated component as illustrated in FIG. 4. Thus, the assembling process of the cap assembly 30 may be simplified.

The cap assembly 30 may further include an insulating material 34 disposed below the safety vent 32, and a lower cap 35 formed of a metal having electric conductivity and disposed under the insulating material 34. A through hole is formed in a center of the lower cap 35, and thus the protrusion 32a of the safety vent 32 may be exposed downward. The lower cap 35 and the safety vent 32 are electrically connected to each other via the insulating material 34.

The cap assembly 30 may further include a subplate 36 formed of a metal having electric conductivity and disposed below the lower cap 35. The subplate 36 is connected to the protrusion 32a of the safety vent 32.

The positive electrode tab 24 (FIGS. 1 and 3) which protrudes over the electrode assembly 20 may be connected to a bottom surface of the lower cap 35 and the subplate 36.

The cap assembly 30 may further include a gasket 39 (FIG. 3) which surrounds circumferential surfaces of the cap 31, the safety vent 32, the PTC resistance layer 33, and the lower cap 35. The gasket 39 has a ring shape, and an inner surface thereof is curved so as to correspond to the circumferential surfaces of the cap 31, the safety vent 32, the PTC resistance layer 33, and the lower cap 35.

The cap assembly 30 may be manufactured by forming an assembly in which components are integrally coupled with one another, and by surrounding the assembly with the gasket 39, or by sequentially stacking the components in the gasket 39.

After coupling the cap assembly 30 to the open portion 11 (FIG. 1) of the can 10, a clamping operation in which pressure is applied inwardly and downwardly to a wall body of the open portion 11 is performed to seal the can 10.

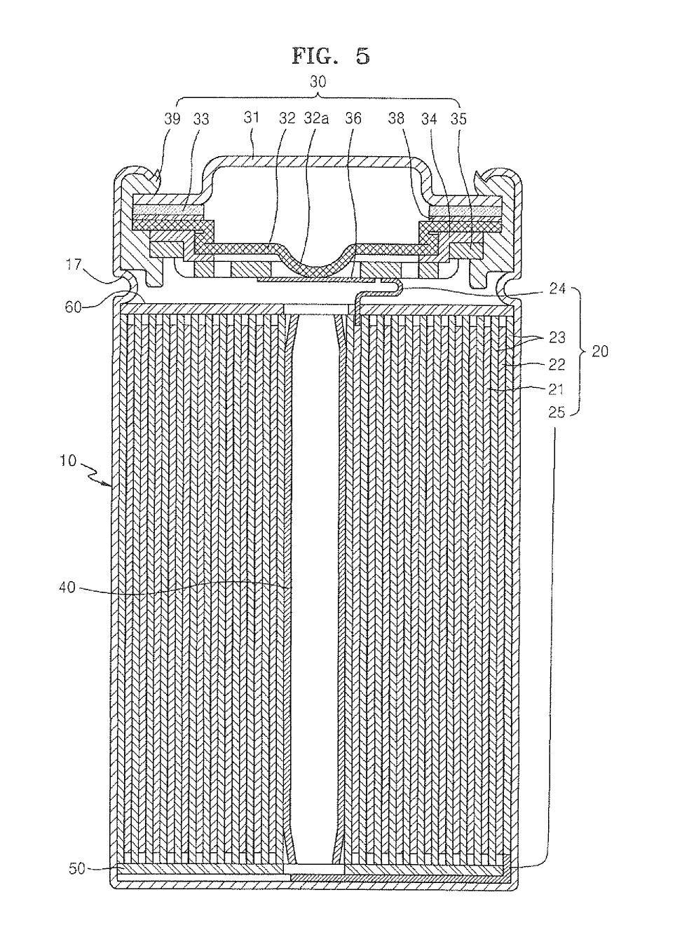

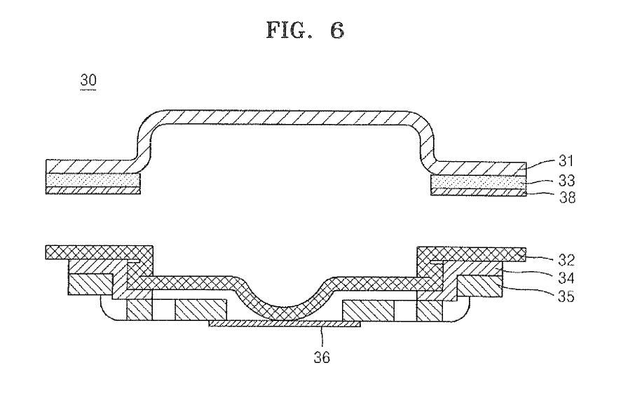

FIG. 5 is a cross-sectional view illustrating a secondary battery, including a cap assembly, according to another embodiment of the present invention; and FIG. 6 is an exploded perspective view illustrating the coupling relationship between elements of the cap assembly included in the secondary battery of FIG. 5.

The secondary battery including the cap assembly 30 illustrated in FIGS. 5 and 6 includes a can 10, an electrode assembly 20 accommodated in the can 10, and a cap assembly 30 which closely seals the can 10.

The cap assembly 30 and the secondary battery illustrated in FIGS. 5 and 6 are similar to the cap assembly 30 and the secondary battery illustrated in FIGS. 1 thru 4, except for the configuration of the cap assembly 30. In FIGS. 5 and 6, like elements as in FIGS. 1 thru 4 are denoted with like reference numerals.

The cap assembly 30 includes a cap 31 which functions as an electrode terminal, a safety vent 32 disposed below the cap 31, a PTC resistance layer 33 disposed between the cap 31 and the safety vent 32, and a metal layer 38 formed of an electrically conductive material and disposed between the PTC resistance layer 33 and the safety vent 32.

A surface of the PTC resistance layer 33 is attached to a bottom surface of the cap 31, and the other surface of the PTC resistance layer 33 is attached to an upper surface of the metal layer 38. Accordingly, the assembling operation needed to couple a PTC device between the cap 31 and the safety vent 32 for assembling the cap assembly 30 may be simplified. Also, since the attachment of the PTC resistance layer 33 to the metal layer 38 and the cap 31 is maintained, the total electrical resistance of the cap assembly 30 is reduced.

The PTC resistance layer 33 may be attached to the cap 31 and the metal layer 38 by using various methods. For example, the PTC resistance layer 33, the cap 31 and the metal layer 38 may be integrated with one another such that the cap 31 and metal layer 38 are attached to the PTC resistance layer 33 by applying pressure thereto when fusing a conductive polymer composition which is a source material of the PTC resistance layer 33.

Alternatively, the PTC resistance layer 33 is manufactured in the form of a ring-shaped circular plate by pressing a conductive polymer composition and cutting the same, and a metal layer 38 is manufactured in the form of a ring-shaped circular plate corresponding to a surface of the PTC resistance layer 33 by cutting a conductive metal thin film. Also, the cap 31 is attached to a surface of the PTC resistance layer 33, and the metal layer 38 is attached to the other surface of the PTC resistance layer 33. When attaching the PTC resistance layer 33 to the cap 31 and the metal layer 38, for example, a conductive adhesive may be used.

Then, a safety vent 32, an insulating material 34, a lower cap 35, and a subplate 36 are disposed below the cap 31 under which the PTC resistance layer 33 and the metal layer 38 are integrated, and then, by surrounding circumferential surfaces of these components with a gasket 39, the cap assembly 30 is completed. The cap assembly 30 may be manufactured by forming an assembly in which components are integrally coupled to one another and surrounding the assembly with a gasket 39, or by sequentially stacking the components in the gasket 39.

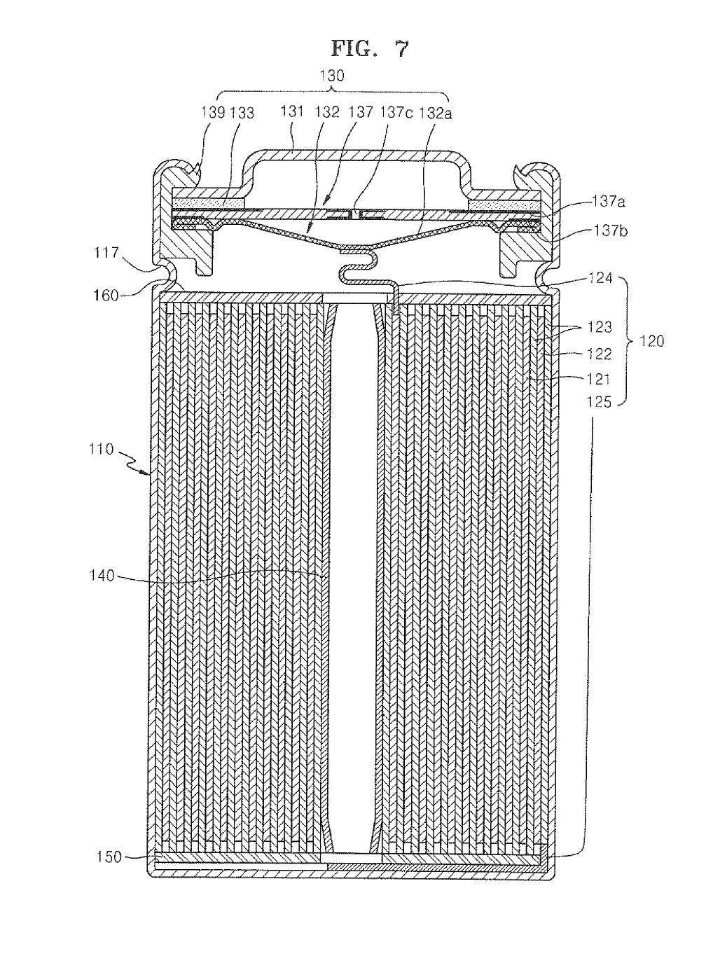

FIG. 7 is a cross-sectional view illustrating a secondary battery, including a cap assembly, according to another embodiment of the present invention.

The secondary battery illustrated in FIG. 7 includes a can 110, an electrode assembly 120 accommodated in the can 110, and a cap assembly 130 which closely seals the can 110. The configuration of the cap assembly 130 is modified from that of the previous embodiment, but a detailed description of the configuration of the can 110 and the electrode assembly 120 is the same as in the embodiments illustrated in FIGS. 1 thru 4, and thus it will be omitted in the description of the present embodiment.

The electrode assembly 120 is formed by interposing a separator 123 between a positive electrode plate 121 and a negative electrode plate 122, and by winding the stack of the positive electrode plate 121, the separator 123, and the negative electrode plate 122 in the form of a jelly roll. A positive electrode tab 124 is attached to the positive electrode plate 121 of the electrode assembly 120, and a negative electrode tab 125 is attached to the negative electrode plate 122. A center pin 140 is inserted into a center portion of the wound electrode assembly 120 so as to prevent deformation of the electrode assembly 120.

A bottom surface of the electrode assembly 120 is insulated from the can 110 via a lower insulation plate 150. An upper insulation plate 160 is disposed on an upper surface of the electrode assembly 120. The can 110 includes a bead 117 formed by inwardly bending a portion of a sidewall of the can 110 at a height of the upper insulation plate 160.

The cap assembly 130 includes a cap 131 which functions as an electrode terminal, a PTC resistance layer 133 disposed under the cap 131, a current blocking circuit substrate 137 disposed under the PTC resistance layer 133, and a safety vent 132 disposed under the current blocking circuit substrate 137.

The current blocking circuit substrate 137 includes an upper circuit pattern 137a formed on an upper surface thereof and a lower circuit pattern 137b formed on a lower portion thereof. The upper circuit pattern 137a and the lower circuit pattern 137b are electrically connected to each other through a via hole 137c formed in a center portion of the current blocking circuit substrate 137.

The safety vent 132 includes a curved surface 132a which is curved downward. A boundary of the safety vent 132 is closely coupled to the lower circuit pattern 137b formed on the lower surface of the current blocking circuit substrate 137.

The positive electrode tab 124 is electrically connected to the safety vent 132. The safety vent 132 blocks an electrical connection such that the current blocking circuit substrate 137 is broken as the curved surface 132a increases when an inner pressure of the can 110 increases to a critical value or greater. That is, electrical connection is cut off in the safety vent 132 and the current blocking circuit substrate 137, thereby blocking current flow. A center portion of the safety vent 132 is ruptured so as to thereby discharge gas generated in an inner portion of the can 110.

In the cap assembly 130, no metal electrode layer is formed on either surface of the PTC resistance layer 133, and a surface of the PTC resistance layer 133 is attached to a lower surface of the cap 131, and the other surface of the PTC resistance layer 133 is attached to the upper circuit pattern 137a of the upper surface of the current blocking circuit substrate 137.

As the cap 131 directly contacts the PTC resistance layer 133 and the upper circuit pattern 137a, they function as metal electrode layers which transmit electricity to the PTC resistance layer 133, the assembly of the cap 131, the safety vent 132, and the current blocking circuit substrate 137, which may function as a PTC device. Thus, compared to a cap assembly of a secondary battery according to the related art, in which a PTC device is additionally installed, in the invention, resistance in the cap assembly 130, in which the PTC resistance layer 133 is integrally included, is significantly reduced.

When attaching the PTC resistance layer 133 and the cap 131 and the current blocking circuit substrate 137 to one another, for example, the cap 131 and the current blocking circuit substrate 137 may be attached to the PTC resistance layer 133 by applying pressure thereto when fusing a conductive polymer composition, which is a source material of the PTC resistance layer 133.

Alternatively, a conductive polymer composition may be pressed and then cut to manufacture the PTC resistance layer 133 in a ring-shaped circular plate, and the cap 131 may be attached to a surface of the PTC resistance layer 133 and the current blocking circuit substrate 137 may be attached to the other surface of the PTC resistance layer 133. The PTC resistance layer 133 may be attached to the cap 31 or the current blocking circuit substrate 137 by using, for example, a conductive adhesive.

When the cap 131 and the safety vent 132 are attached to the current blocking circuit substrate 137, they may be treated as one integrated component, thereby simplifying the assembly process of the cap assembly 130. The cap assembly 130 may further include a gasket 139 which surrounds circumferential surfaces of the cap 131, the PTC resistance layer 133, the current blocking circuit substrate 137, and the safety vent 132.

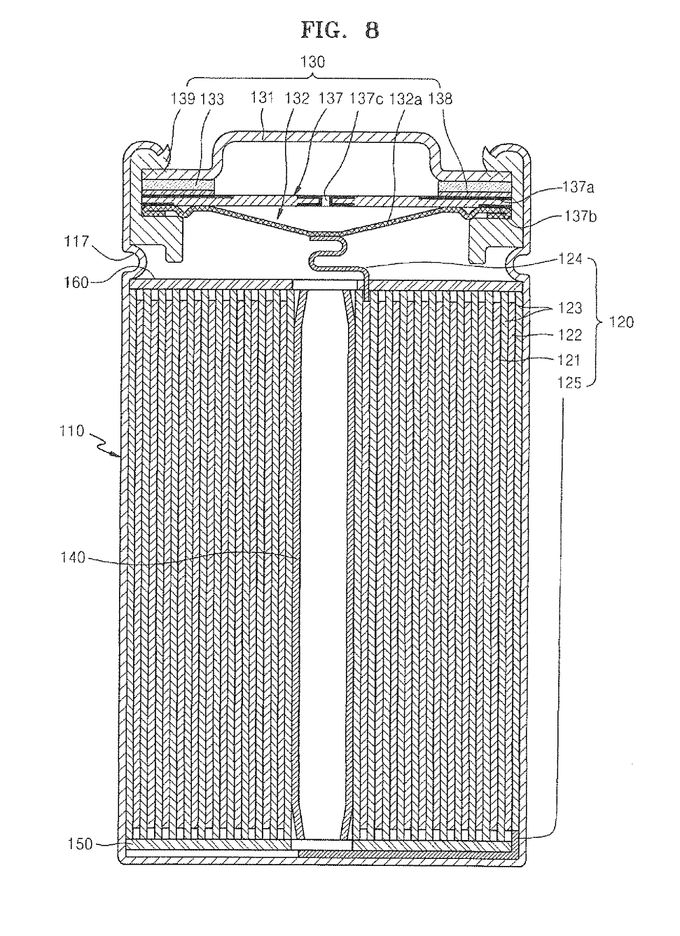

FIG. 8 is a cross-sectional view illustrating a secondary battery, including a cap assembly, according to another embodiment of the present invention.

The cap assembly 130, and the secondary battery including the same, as illustrated in FIG. 8, are similar to that illustrated in FIG. 7 except for the configuration of the cap assembly 130.

The cap assembly 130 includes a cap 131 which functions as an electrode terminal, a PTC resistance layer 133 disposed below the cap 131, a current blocking circuit substrate 137 disposed below the PTC resistance layer 133, a metal layer 138 disposed between the PTC resistance layer 133 and the current blocking circuit substrate 137, and a safety vent 132 disposed below the current blocking circuit substrate 137.

A surface of the PTC resistance layer 133 is attached to a lower surface of the cap 131, and the other surface of the PTC resistance layer 133 is attached to an upper surface of the metal layer 138. The cap 131 includes the PTC resistance layer 133 and the metal layer 138, and they may be treated as one component. Accordingly, an assembling operation needed to couple a PTC device between a cap 131 and a safety vent 132 for assembling the cap assembly 130 may be simplified. Also, since the attachment of the PTC resistance layer 133 to the metal layer 138 and the cap 131 is maintained, the total electrical resistance of the cap assembly 130 is reduced.

When attaching the PTC resistance layer 133 to the cap 131 and the metal layer 138, a conductive polymer composition, which is a source material of the PTC resistance layer, may be fused, and the cap 131 and the metal layer 138 may be attached to the PTC resistance layer 133 by applying pressure thereto, or the PTC resistance layer 133 formed in a ring-shaped circular plate in advance may be attached to the cap 131 and the metal layer 138 by using a conductive adhesive.

As described above, in the cap assembly and the secondary battery, including the cap assembly, according to the one or more of the above embodiments of the present invention, metal electrode layers are not additionally disposed on both surfaces of the PTC resistance layer, but components of the cap assembly are integrally attached to the PTC resistance layer so as to function as electrode layers, and thus electrical resistance of the cap assembly is reduced.

Also, the PTC resistance layer is integrally attached between the cap, and the safety vent of the cap assembly, and thus the cap assembly may be easily manufactured in the form of one assembly.

Also, if the PTC resistance layer is integrally attached below the cap, or between the cap and the safety vent, or between the cap and the current blocking circuit substrate, the components integrated with one another may be treated as one component, and thus the cap assembly may be easily assembled.

It should be understood that the exemplary embodiments described herein should be considered in a descriptive sense only and not for purposes of limitation. Descriptions of features or aspects within each embodiment should typically be considered as available for other similar features or aspects in other embodiments.

What is claimed is:

1. A cap assembly of a secondary battery, comprising:
a cap formed of a metal having electric conductivity;
a safety vent formed of a metal having electric conductivity, and disposed below the cap; and
a positive temperature coefficient (PTC) resistance layer which includes a conductive polymer composition having PTC characteristics, and which is disposed between the cap and the safety vent.

2. The cap assembly of claim 1, wherein a surface of the PTC resistance layer is attached to a bottom surface of the cap, and another surface of the PTC resistance layer is attached to an upper surface of the safety vent.

3. The cap assembly of claim 1, further comprising a metal layer formed of a material having electric conductivity and formed between the PTC resistance layer and the safety vent, wherein a surface of the PTC resistance layer is attached to a bottom surface of the cap, and another surface of the PTC resistance layer is attached to an upper surface of the metal layer.

4. The cap assembly of claim 1, further comprising a current blocking circuit substrate interposed between the PTC resistance layer and the safety vent, wherein a surface of the PTC resistance layer is attached to a bottom surface of the cap, and another surface of the PTC resistance layer is attached to a terminal disposed on an upper surface of the current blocking circuit substrate.

5. The cap assembly of claim 1, further comprising a metal layer formed of a material having electric conductivity and a current blocking circuit substrate, said metal layer and said current blocking circuit being sequentially disposed below the PTC resistance layer, wherein a surface of the PCT resistance layer is attached to a bottom surface of the cap, and wherein another surface of the PTC resistance layer is attached to an upper surface of the metal layer, and a bottom surface of the metal layer is attached to a terminal disposed on an upper surface of the current blocking circuit substrate.

6. The cap assembly of claim 1, further comprising an insulating material disposed below the safety vent, and a lower cap formed of a metal having electric conductivity and disposed below the insulating material.

7. The cap assembly of claim 6, further comprising a subplate formed of a metal having electric conductivity and disposed below the lower cap.

8. The cap assembly of claim 1, further comprising a gasket which surrounds circumferential surfaces of the cap, the safety vent, and the PTC resistance layer, and which insulates the can and the cap assembly of the secondary battery from each other.

9. A secondary battery, comprising:
a can including an open portion at one side;
an electrode assembly accommodated in the can; and
a cap assembly comprising:
a cap formed of a metal having electric conductivity;
a safety vent formed of a metal having electric conductivity and disposed below the cap; and
a positive temperature coefficient (PTC) resistance layer which includes a conductive polymer composition having PTC characteristics and disposed between the cap and the safety vent, wherein the cap assembly is coupled to the can so as to seal the can.

10. The secondary battery of claim 9, wherein a surface of the PTC resistance layer is attached to a bottom surface of the cap, and another surface of the PTC resistance layer is attached to an upper surface of the safety vent.

11. The secondary battery of claim 9, further comprising a metal layer formed of a material having electric conductivity and disposed between the PTC resistance layer and the safety vent, wherein a surface of the PTC resistance layer is attached to a bottom surface of the cap, and another surface of the PTC resistance layer is attached to an upper surface of the metal layer.

12. The secondary battery of claim 9, further comprising a current blocking circuit substrate interposed between the PTC resistance layer and the safety vent, wherein a surface of the PTC resistance layer is attached to a bottom surface of the cap, and another surface of the PTC resistance layer is attached to an upper surface of the metal layer.

13. The secondary battery of claim 9, further comprising a metal layer formed of a material having electric conductivity and a current blocking circuit substrate, said metal layer and said current blocking circuit being sequentially disposed below the PTC resistance layer, wherein a surface of the PTC resistance layer is attached to a bottom surface of the cap, another surface of the PTC resistance layer is attached to an upper surface of the metal layer, and a bottom surface of the metal layer is attached to a terminal disposed on an upper surface of the current blocking circuit substrate.

14. The secondary battery of claim 9, wherein the electrode assembly comprises:
a first electrode plate to which a first electrode tab, which protrudes over an open portion of the can, is connected;
a second electrode plate to which a second electrode tab, which protrudes toward a lower portion of the can, is connected; and
a separator interposed between the first electrode plate and the second electrode plate.

15. The secondary battery of claim 14, further comprising an insulating material disposed below the safety vent, a lower cap formed of a metal having electric conductivity and disposed below the insulating material, and a subplate formed of a metal having electric conductivity and disposed below the lower cap, said subplate being connected to the first electrode tab.
